(19) United States
(12) Patent Application Publication
(10) Pub. No.: US 2014/0355996 A1
(43) Pub. Date: Dec. 4, 2014

(54) HIGH DEFINITION MULTIMEDIA INTERFACE AND NETWORK INTERFACE ADAPTER DEVICE

(71) Applicant: HON HAI PRECISION INDUSTRY CO., LTD., New Taipei (TW)

(72) Inventor: I-THUN LIN, New Taipei (TW)

(73) Assignee: HON HAI PRECISION INDUSTRY CO., LTD., New Taipei (TW)

(21) Appl. No.: 14/014,429

(22) Filed: Aug. 30, 2013

(30) Foreign Application Priority Data
May 29, 2013 (TW) 102118882

(51) Int. Cl. H04B 10/80

(52) U.S. Cl. CPC H04B 10/801
USPC 398/117

(57) ABSTRACT

An adapter device converting HDMI signals to a format suitable for network transmission includes a HDMI module, a network module, and a light guiding pipe between the two. The HDMI module includes a HDMI plug and a first photoelectric converter. The network module includes a network plug, a second photoelectric converter, and a buffer between the second photoelectric converter and the network plug. The light guiding pipe is connected between the first photoelectric converter and the second photoelectric converter. Video/audio signals output from the HDMI plug are converted to light signals via the first photoelectric converter and the photoelectric converter converts the light signals to video/audio signals. The video/audio signals are stored in the buffer, and are orderly output from network plug to the network.

### BACKGROUND

1. Technical Field

The present disclosure relates to adapting devices and, particularly, to an adapting device of an HDMI (high definition multimedia interface) and a network interface.

2. Description of Related Art

At present, video/audio signals output from HDMIs can not be directly transmitted to other electronic devices via network interfaces as the HDMIs cannot physically connect to the network interface. Specifically, the HDMIs generally include 19 pins while the network interfaces include 8 pins.

Therefore, it is desirable to provide an adapting device that can overcome the limitations described.

### BRIEF DESCRIPTION OF THE DRAWINGS

FIG. 1 is a schematic view of an adapting device in accordance with an exemplary embodiment.

FIG. 2 is a function block diagram of the adapting device of FIG. 1.

FIG. 3 is a view of the adapting device of FIG. 1 in a state of use.

### DETAILED DESCRIPTION

Embodiments of the disclosure will be described with reference to the drawings.

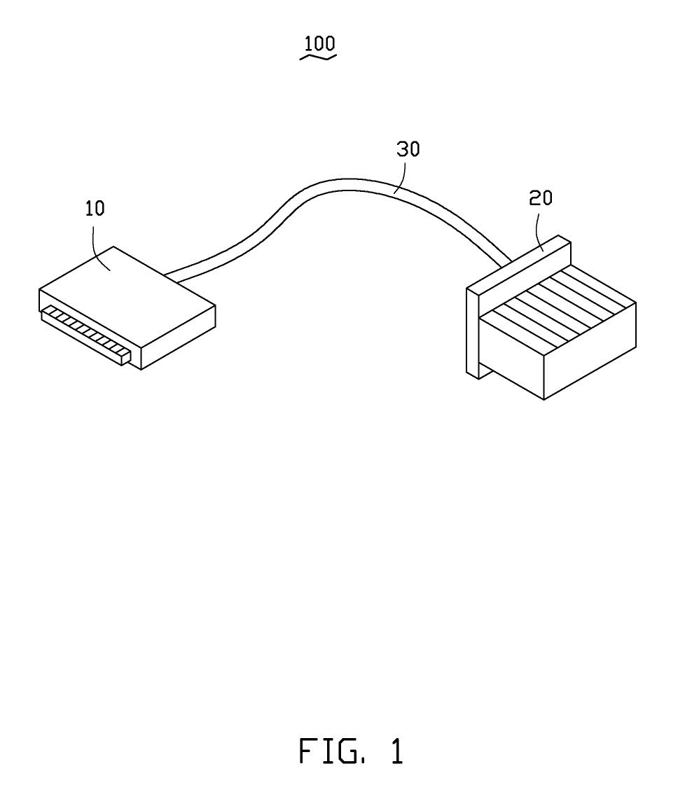

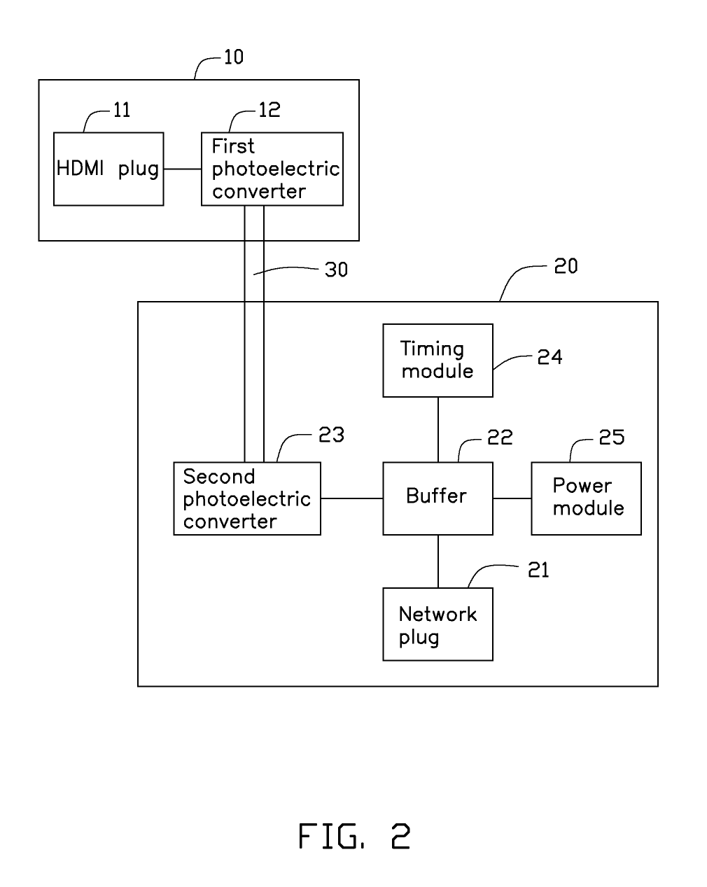

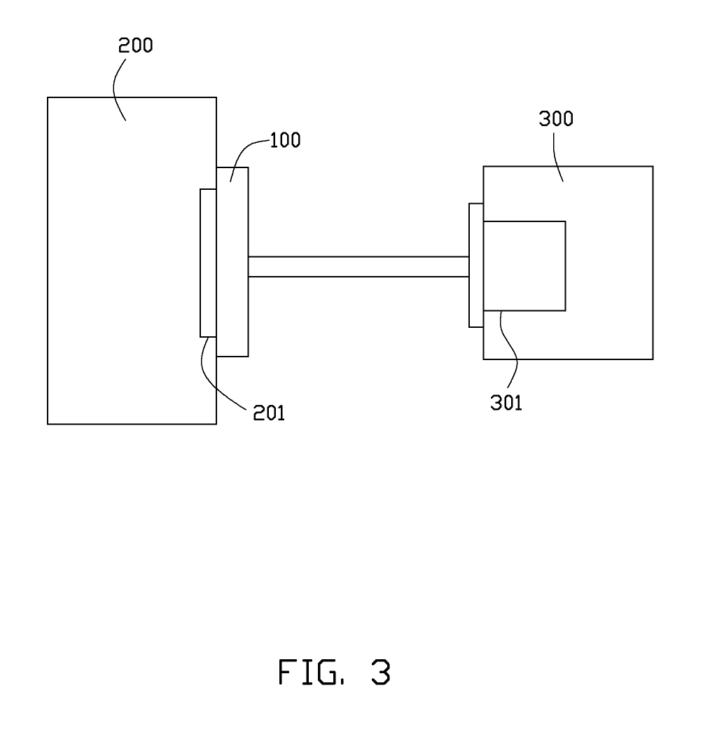

FIGS. 1-3 show an adapting device 100, according to an exemplary embodiment. The adapting device 100 is connected between a video/audio outputting device 200 and an electrical device 300. The video/audio outputting device 200 includes a HDMI socket 201 and the electrical device 300 includes a network socket 301. The HDMI socket 201 includes 19 pins, and the network socket 301 includes 8 pins. In the embodiment, a type of the HDMI socket 201 is HDMI 1.4, and a type of the network socket 301 is RJ-45.

The adapting device 100 includes a HDMI module 10, a network module 20, and a light guiding pipe 30 connected between the HDMI module 10 and the network module 20.

The HDMI module 10 includes a HDMI plug 11 and a first photoelectric converter 12 connected to the HDMI plug 11. The HDMI plug 11 includes 19 pins corresponding to the HDMI socket 201, and is configured for transferring or receiving video/audio signals. The first photoelectric converter 12 is configured for converting electrical signals output from the HDMI plug 11 to light signals, and for converting the light signals received from the light guiding pipe 30 to electrical signals.

In the embodiment, pins 1 through 9 of the HDMI plug 11 are three transition minimized differential signaling (TMDS) data channels, pins 10 through 12 are a TMDS clock channel, pin 13 is a consumer electronics control (CEC) channel, pin 14 is reserved, pins 15 and 16 as a pair are a display data channel (DDC) channel, pin 17 is a data shield for the CEC and DDC channels, pin 18 is a power terminal, and pin 19 is a hot plug detector.

The network module 20 includes a network plug 21, a buffer 22, a second photoelectric converter 23, a timing module 24, and a power module 25. The network plug 21 includes 8 pins corresponding to the network socket 301, and is configured for transferring or receiving network signals. The buffer 22 is electrically connected between the network plug 21 and the second photoelectric converter 23. The buffer 22 is 32 bits in capacity, and video/audio signals output from the HDMI plug 11 are orderly stored in the buffer 22. The second photoelectric converter 23 is configured for converting the light signals received from the light guiding pipe 30 to electrical signals and converting electrical signals output from the network plug 21 to light signals. The timing module 24 is electrically connected to the buffer 22, and generates timing signals. The power module 25 is electrically connected to the buffer 22 and the timing module 24, and supplies power to the buffer 22 and the timing module 24.

In the embodiment, pins 1 and 2 of the network plug 21 are a data transmit channel, pins 3 and 6 are a data receive channel, and pins 4, 5, 7, and 8 are reserved.

In the embodiment, each of the first photoelectric converter 12 and the second photoelectric converter 23 includes at least one laser diode and at least one photo diode.

The light guiding pipe 30 includes a transparent core surrounded by a transparent cladding material of a lower refraction index. The light guiding pipe 30 is connected between the first photoelectric converter 12 and the second photoelectric converter 23. The light signals from the HDMI module 10 are transmitted to the network module 20 or the light signals emitted from the network module 20 are transmitted to the HDMI module 10 via the light guiding pipe 30.

In use, the video/audio signals output from the video/audio outputting device 200 are output to the HDMI plug 11 via the HDMI socket 201. The first photoelectric converter 12 converts the video/audio signals into light signals. The light signals are transmitted to the second photoelectric converter 23 via the light guiding pipe 30. The second photoelectric converter 23 converts the light signals into video/audio signals, and the video/audio signals are orderly stored in the buffer 22. To adapt to the network plug 21, the video/audio signals are divided into a number of groups of signals under the timing signal output from the timing module 24, the number of the bits of each group is not more than eight. The groups of signals are orderly output to the network socket 301 of the electrical device 300 via the network plug 21.

In the embodiment, the video/audio signals are divided into a first 8 bit signal, a second 8 bit signal, and a final 3 bit signal. After the first timing signal, the first 8 bit signal is transmitted to the network socket 301. After the second timing signal, the second 8 bit signal is transmitted to the network socket 301. After the third timing signal, the 3 bit signal is transmitted to the network socket 301.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An adapting device, comprising:
a HDMI module comprising a HDMI plug and a first photoelectric converter connected to the HDMI plug;
a network module comprising a network plug, a buffer, a second photoelectric converter; the buffer connected between the network plug and the second photoelectric converter; and
a light guiding pipe connected between the first photoelectric converter and the second photoelectric converter;
wherein video/audio signals output from the HDMI plug are converted to light signals via the first photoelectric converter, the light guiding pipe transmits the light signals to the second photoelectric converter, the second photoelectric converter converts the light signals to the video/audio signals, the video/audio signals are stored in the buffer, and are orderly output from the network plug.

2. The adapting device of claim 1, wherein the HDMI plug comprises 19 pins, and the network plug comprises 8 pins.

3. The adapting device of claim 2, wherein the buffer is 32 bits in capacity, and video/audio signals outputting from the HDMI plug are orderly stored in the buffer.

4. The adapting device of claim 3, wherein the network module comprises a timing module, the video/audio signals are orderly output to the network plug under a timing signal outputting from the timing module.

5. The adapting device of claim 4, wherein the network module comprises a power module electrically connected to the buffer and the timing module, and is configured for supplying power to the buffer and the timing module.

6. The adapting device of claim 1, wherein the video/audio signals are divided into a plurality of groups of signals adapting to the network plug under the timing signal outputting from the timing module, the number of the bits of each group is not more than eight.

7. An adapting device, comprising:
a HDMI module;
a network module comprising a buffer; and
a light guiding pipe connected between the HDMI module and the network module;
wherein video/audio signals output from the HDMI module are transmitted to and stored in the buffer; the video/audio signals are orderly output from the network module.

8. The adapting device of claim 7, wherein the video/audio signals are divided into a plurality of groups of signals adapting to the network module, the number of the bits of each group is not more than eight.
